(19) United States
(12) Patent Application Publication
(10) Pub. No.: US 2011/0014444 A1
(43) Pub. Date: Jan. 20, 2011

(54) UV PROTECTING TREATMENT FOR WOODEN INTERIOR TRIM

(76) Inventors: Jessica Alessandro, Dublin, OH (US); Corey McEnhill, Dublin, OH (US)

Correspondence Address: Capitol City TechLaw, PLLC, 113 S. Columbus St., Suite 302, Alexandria, VA, 22314, US

(21) Appl. No.: 12/504,745

(22) Filed: Jul. 17, 2009

(51) Int. Cl. B32B 7/02; B05D 1/36; B32B 37/02

(52) U.S. Cl. 428/218; 427/160; 156/154

(57) ABSTRACT

The present disclosure is directed to a process for protecting wood components of the interior of an automotive vehicle from UVA radiation by coating the top surface of a stained wood substrate with a low gloss polyurethane-containing topcoat having a UV absorber and HALS component incorporated therein. The wood component can have a 60 degree surface gloss rating no greater than about 30 gloss units measured according to ASTM D523-08 test conditions. Methods of producing the vehicle interior component are also disclosed.

### BACKGROUND

1. Field of the Invention

The present disclosure relates to methods of treating medium to dark-colored wood substrates to produce a wood substrate with a low gloss appearance that provides enhanced protection from ultraviolet (“UV”) radiation and a “real” wood look and hand. The present disclosure also relates to the wood components produced by the methods disclosed herein.

2. Description of the Related Art

Real wood trim pieces with very glossy finishes in some automotive vehicles are difficult to distinguish from plastic woodgrain films. A simple polyurethane (herein “PU”) coating can have the desired appearance but typically cannot meet rigorous performance targets for, for example, long term resistance to fading upon extended exposure to sunlight.

However, real wood remains a popular choice for the interior of upscale and luxury automobiles. In order to meet rigorous performance targets multiple coats of high gloss PU finishes are routinely used with real wood trim pieces in automotive vehicles in an attempt to meet the light resistance standard and other performance criteria, but the thick coating completely fills the natural pores of the wood and the resulting glossy, almost mirror-like finish can easily confuse the ordinary consumer as to the composition of the material, that is, real wood or plastic film.

A method of achieving the necessary resistance to UV induced aging while maintaining a “real” wood appearance, that is, not a high gloss finish, is of interest.

### SUMMARY OF THE PRESENT DISCLOSURE

The present disclosure is directed to a method of protecting a wood substrate from UVA radiation by providing a wood substrate having a top surface, coating the top surface of the wood substrate with a stain to produce a stained wood substrate, and coating the stained wood substrate with only one application of a topcoat composition including a low gloss polyurethane, a UV absorber component, and a HALS component. In the present method, the stain composition can be coated onto the wood substrate in a concentration greater than about 70 g/m², the topcoat composition can be a composition which provides a 60 degree surface gloss rating of no greater than about 30 gloss units measured according to ASTM D523-08 test conditions, the UV absorber component and the HALS component can be present in a ratio of about 2:1 on a weight percent basis, and the one application of the topcoat composition results in a topcoat having a thickness ranging between about 16 and about 23 μm.

The present method can also include the additional steps of adhering the wood substrate to a support component made of metal, plastic or a composite material to form a part. The part can be machined to the desired dimensions, and then located within an automotive interior.

### BRIEF DESCRIPTION OF THE DRAWINGS

The accompanying drawings, which are included to provide a further understanding of the present teachings and are incorporated in and constitute a part of this specification, illustrate various exemplars of the present teachings and together with the detailed description serve to explain the principles of the present teachings.

In the drawings:

FIG. 1 is a graph showing effect of the ratio of UV absorbing additives to HALS for wood substrates prepared according to the present teachings;

FIG. 2 is a chart of grading results showing effect of the amount of stain for wood substrates prepared according to the present teachings, and

FIG. 3 is a chart of grading results showing effect of the topcoat thickness for wood substrates prepared according to the present teachings.

### DETAILED DESCRIPTION

Wood is composed of three primary components, lignin, cellulose, and hemicellulose. Cellulose and hemicellulose are, respectively, short branched chains of glucose and long straight chains of glucose. Lignin is described as a three dimensional phenolic polymer that binds the cellulose fibers together, that is, glue for the wood structure. About 38 to 50 wt. % of wood is cellulose; about 23 to 32 wt. % is hemicellulose, and about 15 to 25 wt. % of wood is composed of lignin.

Of the three components, lignin is the most sensitive to degradation due to photo-oxidation. UVA radiation can degrade the lignin and lead to a noticeable color change, typically greening, of the wood.

Automotive interior components typically can be exposed to levels of heat, UVA, UVB, and IR radiation which can detrimentally affect the appearance of the interior component, particularly wood-based components, over time. Furthermore, low gloss finishes for components such as dashboard skin components are desired in order to avoid causing distracting and annoying glare.

Disclosed by this application is a method of protecting a wood substrate from UVA radiation by providing a wood substrate having a top surface, coating that top surface of the wood substrate with a stain to produce a stained wood substrate, and coating the stained wood substrate with only one application of a topcoat composition comprising a low gloss polyurethane, a UV absorber component, and a HALS component to produce a UVA-protected wood substrate. In the presently taught method, the stain composition can coated onto the wood substrate at a concentration greater than about 70 g/m². The topcoat composition utilized in the present method can be a composition which provides a 60 degree surface gloss rating of no greater than about 30 gloss units measured according to ASTM D523-08 test conditions. The topcoat composition includes a UV absorber component and a HALS component present in a ratio of about 2:1 on a weight percent basis, and the method calls for only one application of the topcoat composition which results in a topcoat having a thickness ranging between about 16 and about 23 μm.

The application of the topcoat in the presently disclosed method can result in a finished wood piece having the feel (or “hand”) of open pores, and not a mirror or glass-like feel. The topcoat can be sufficiently thick to provide protection from the elements to be expected in the interior of an automobile vehicle.

According to the presently disclosed method, the topcoat composition can result in a finished topcoat having a thickness ranging between about 16 and about 23 μm. In some embodiments, the topcoat should be of sufficient thickness to provide the wood with protection against exposure to the elements such as, moisture and scratching. In some examples of the present method, the topcoat can be applied in a single application and can have a thickness to provide an open pore feel to the top surface of the wood substrate. Particularly undesirable is having a topcoat of such properties, primarily thickness, that a glass-like feel to the wood is achieved.

The topcoat applied to the wood component of the present disclosure can have incorporated therein, further additives to provide, for example, enhanced resistance to moisture, scratches and infrared radiation.

The disclosed method can result in an attenuation of the transmission of UVA radiation to the top surface of the wood by at least about 80%, or in other cases, by at least about 90%, as compared to untreated wood substrates.

The UV absorbers can include organic UV absorbers. Suitable organic UV stabilizers for the topcoat composition according to the present disclosure can include, for example, at least one member selected from the group consisting of a cyanacrylate, an oxalanilide, a benzotriazole, a triazine, an hydroxyphenylbenzotriazole, 2-hydroxy-4-n-octoxybenzophenone, 2,2′-dihydroxy-4-methoxybenzophenone, poly-4-(2-acryloxyethoxy)-2-hydroxybenzophenone, [2,2′-thiobis(4-t-octylphenolate)]-n-butylamine nickel(II), 2,2′-(1,4-phenylene)bis[4H-3,1-benzoxazin-4-one], 2-(2′-hydroxy-5′-octylphenyl)-benzotriazole, 2-(2′-hydroxy-3′,5′-di-t-amylphenyl)benzotriazole, 2,4-bis(2,4-dimethylphenyl)-6-(2-hydroxy-4-iso-octyloxyphenyl)-s-triazine, 2-[4-[(2-hydroxy-3-(2′-ethyl)hexyl)oxy]-2-hydroxyphenyl]-4,6-bis(2,4-dimethylphenyl)-1,3,5-triazine 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine, 2-(2H-benzotriazol-2-yl)-4,6-di-t-pentylphenol, a hexadecyl ester of 3,5-di-t-butyl-4-hydroxybenzoic acid, and mixtures thereof.

For the presently disclosed method, the HALS component can include at least one member selected from the group consisting of hindered amine light stabilizers, monomeric hindered amine light stabilizers, oligomeric hindered amine light stabilizers, derivatives thereof, and mixtures thereof. In other instances of the present method, the HALS component can be a free radical nitroxide-containing component, for instance, a tetra-methyl piperidine-based composition.

For some embodiments of the present method, the HALS component can include at least one member selected from the group consisting of poly[[6-[(1,1,3,3-tetramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]]), poly[(6-morpholino-s-triazine-2,4-diyl)[2,2,6,6-tetramethyl-4-piperidyl)imino]-hexa methylene-[(2,2,6,6-tetramethyl-4-piperidyl)imino]], bis(2,2,6,6-tetramethyl-4-piperidyl)sebacate, bis(1,2,2,6,6-pentamethyl-4-piperidyl)sebacate, methyl 1,2,2,6,6-pentamethyl-4-piperidyl sebacate, 2,2,6,6-tetramethyl-4-piperidyl stearate, 3-dodecyl-1-(2,2,6,6-tetramethyl-4-piperidyl)-pyrrolidin-2,5-dione, and mixtures thereof.

While any wood can be treated by the present method, there is most interest in protecting darker woods by treating with the presently taught method including, for instance, walnut, edinum, European lacewood, zebrano, maple, figured maple, olive ash, eucalyptus, and the suitable burls of any of the above-listed woods. Also, in some embodiments of the present disclosed method, man-made veneers can also be utilized. In most instances the present method will be applied to veneers of a suitable wood.

The present method can further include incorporating the wood substrate into an automotive vehicle interior. The incorporation process can include the steps of adhering the wood substrate to a support component comprising metal, plastic or a composite material to form a part, machining that part to the desired dimensions, and finally locating the part within an automotive interior.

With respect to the staining of the wood substrate, the stain can be applied to the wood at a concentration of between about 70 and about 120 g/m². Depending on the color of the initial wood substrate and the desired final color of the finished wood component the amount, type, and concentration of the stain component can be varied. One of ordinary skill in the art will know how to vary these factors to achieve the desired final effect. In some embodiments of the present method, the stain can be a water-based stain.

A low gloss polyurethane topcoat composition suitable for the various embodiments of the present method can include a composition which provides a 60 degree surface gloss rating with a maximum rating ranging from no greater than about 30 gloss units, about 25 gloss units, about 15 gloss units, or about 10 gloss units measured according to ASTM D523-08 test conditions. Examples of suitable low gloss polyurethane compositions will be known to one of ordinary skill in the pertinent art.

In some embodiments of the present method, polyester or acrylic-containing compositions can be utilized as the topcoat composition. One example of a suitable topcoat is Puridur-Lack Farblos Satin from Voetteler, one especially suitable composition is article 3179-4-0000 from Voetteler.

The treated wood substrate produced by the present method will, in nearly all cases, be located behind and protected by a pane of UVB ray-absorbing or deflecting automotive glass. With the presence of the UVB attenuating glass, the treatment of the wood for the interior compartment can be tailored to protect the wood from the degradation processes due to long term exposure to UVA and visible radiation.

The present disclosure also includes a wood component for the interior of an automotive vehicle. The wood substrate has a top surface with a stain-containing layer located on the top surface, and a polyurethane-containing layer is located on top of the stain-containing layer. This polyurethane-containing layer can include a low gloss polyurethane, a UV absorber component, and a HALS component. The UV absorber component and the HALS component can be present in a ratio of about 2:1 on a weight percent basis, and polyurethane composition can provide a 60 degree surface gloss rating of no greater than about 30 gloss units measured according to ASTM D523-08 test conditions.

The presently disclosed wood component can have a polyurethane-containing layer with a thickness ranging between about 16 and about 23 μm.

The surface gloss of the presently disclosed wood components can be measured by various techniques such as the technique utilized according to ASTM Standard D523-08, 2008, “Standard Test Method For Specular Gloss,” ASTM International, West Conshohocken, Pa., www.astm.org. A Dorigon gloss meter manufactured by HunterLab or a Byk-Malinckrodt gloss meter are some examples of suitable instruments used to provide instrument precision gloss measurements.

Vehicle interior design criteria, type of wood, type of stain, costs, and other numerous production requirements can vary, and one of ordinary skill in the art will know suitable treating and coating parameters to achieve the desired levels of longevity, protection, and other characteristics of the wood substrate.

As used herein, for ease of discussion only, the light spectrum can be divided into several regions, for instance, “UVB” for the portion of the spectrum ranging from 280 to 315 nm, “UVA” for the portion of the spectrum ranging from 315 to 400 nm, and “VIS” for the portion of the spectrum ranging from 400 to 500 nm.

As used herein, “automotive” or “automobile” refers to, for example and without limitation, cars, trucks, buses, motorcycles, all-terrain vehicles, personal watercraft, boats, and other self-propelled vehicles.

All publications, articles, papers, patents, patent publications, and other references cited herein are hereby incorporated herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The following examples are presented to provide a more complete understanding of the present teachings. The specific techniques, conditions, materials, and reported data set forth to illustrate the principles of the principles of the present teachings are exemplary and should not be construed as limiting the scope of the present teachings.

### EXAMPLES

### UV:HALS Ratio

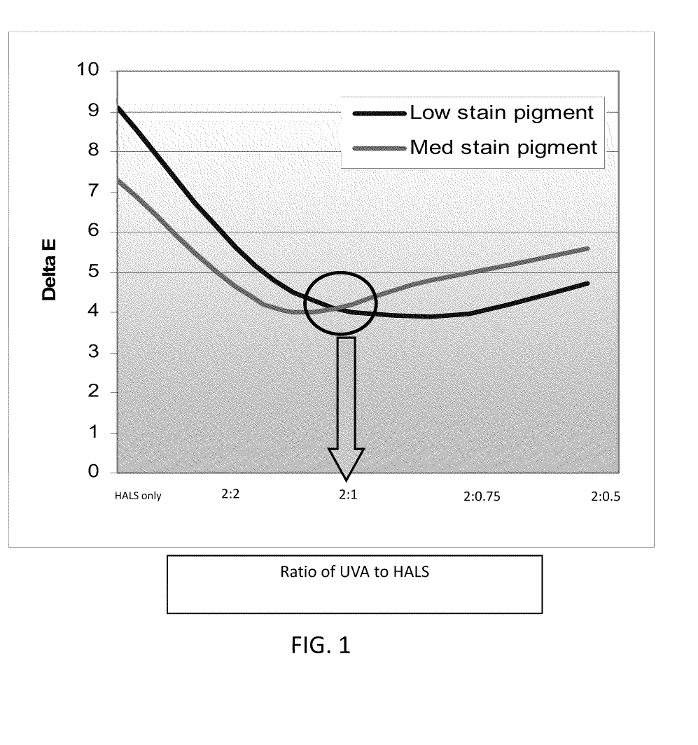

Samples of veneers were stained with either low or medium pigment stains, and then coated with a single coating of a polyurethane-containing composition to obtain a topcoat thickness of about 20 μm. The polyurethane-containing compositions contained varying ratios of UV absorbing additives to HALS components. The examined UV to HALS ratios were HALS only, 2:2, 2:1, 2:0.75, and 2:0.5. The UV absorbing additive loading was at a concentration of 2 wt. %, while the HALS only loading was at 1 wt. %. The UV absorbing additive composition consisted of a 50/50 mixture of benzotriazole and triazine. The samples were then aged, and the ΔE was determined Delta E, or total color difference, is calculated from the differences in the L*, a* and b* values between unaged and aged samples on the CIELAB color scale. The results are presented in FIG. 1 and illustrate that a 2:1 UV:HALS ratio provides the optimum results.

### Stain Loading

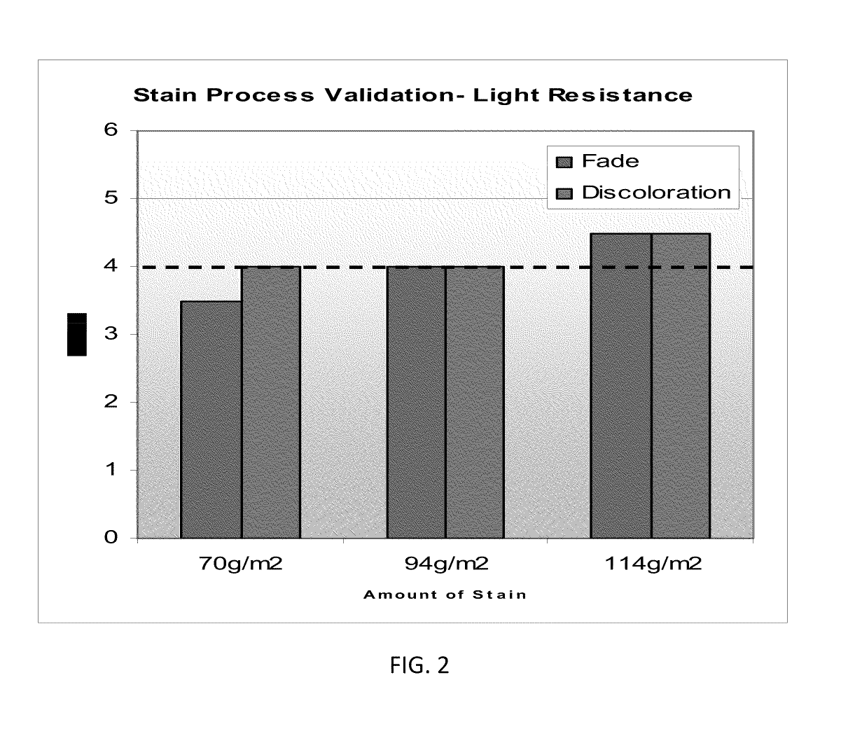

Samples of veneers were stained at varying loading levels, and then coated with a single coating of a polyurethane-containing composition to obtain a topcoat thickness of about 20 μm. The stains loading levels were 70, 94 and 114 g/m². The samples were then aged under light stress, and graded on the 5 point scale. A minimum grade of 4 was targeted. The results are presented in FIG. 2 and illustrate that a stain loading of greater than 70 g/m² is desirable but that greater than 114 g/m² does not provide significant improvement.

### Topcoat Thickness

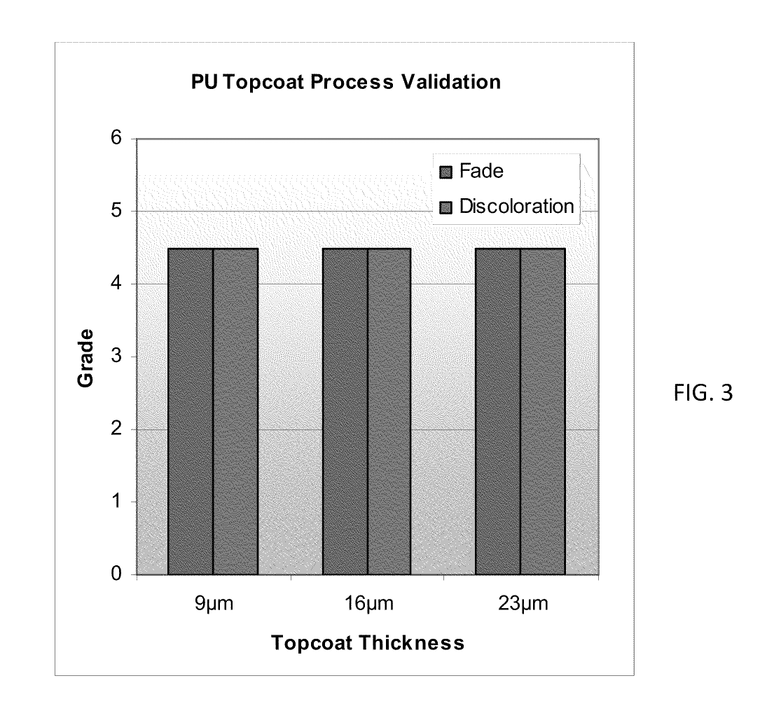

Samples of veneers were stained, and then coated with a single coating of a polyurethane-containing composition to obtain a varying topcoat thicknesses. The examined topcoat thickness were 9, 16, and 23 μm. The samples were then aged, and graded on the 5 point scale. The results are presented in FIG. 3 and illustrate that a topcoat thickness of between 16 and 23 μm provides the optimum results. The coating thickness of 9 μm did not have a satisfactory appearance.

### Heat and Light Resistance

Samples of swirly walnut, edinum, and European lacewood veneers were first coated with a water-based stain at a loading varying between 70 and 120 g/m², dried, and then a single coating of a polyurethane-containing composition to obtain a topcoat thickness of about 20 μm. The polyurethane-containing composition also contained 1 wt. % HALS and 2 wt. % of a UV absorbing additive composition consisting of a 50/50 mixture of benzotriazole and triazine. The samples were then stressed under both light and heat as set forth below, and then graded on a five point scale. The results are presented in Table 1 herein.

### Aging Conditions and Grading

Light aging of samples was accomplished by exposing the samples to 100 MJ of light from an xenon arc lamp at a temperature of 89±3° C. at 50±5% relative humidity to obtain an irradiance of about 48 to about 100 W/m². Heat exposure was accomplished by exposing the samples to 100° C. heat for 500 hours. The samples were then graded on a five point scale.

The five point scale used herein is composed of the following grades; 1—change is very significant, 2—change is of little significance, 3—slight change but clearly recognizable, 4—slight change but almost unrecognizable, and 5—no change as compared to the original unstressed sample.

TABLE 1

| | | Minimum | Swirly | | European |
|---|---|---|---|---|---|
| Test | Exposure | Grade | Walnut | Edinum | Lacewood |
| Light | 100 MJ | Discoloration: | 4.5/4.5 | 4/4.5 | 3/3 |
| Resistance | exposure | 4/Fade: 3 | | | |
| Heat | 100° C. for | Discoloration: | 4.5/4.5 | 4/4.5 | 4/4.5 |
| Resistance | 500 hours | 4/Fade: 3 | | | |

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What we claim is:

1. A method of protecting a wood substrate from UVA radiation comprising:
providing a wood substrate having a top surface;
coating the top surface of the wood substrate with a stain composition to produce a stained wood substrate; and
coating the stained wood substrate with only one application of a topcoat composition comprising a low gloss polyurethane, a UV absorber component, and a HALS component,
wherein the stain composition is coated at a concentration greater than about 70 g/m², the topcoat composition comprises a composition which provides a 60 degree surface gloss rating of no greater than about 30 gloss units measured according to ASTM D523-08 test conditions, the UV absorber component and the HALS component are present in a ratio of about 2:1 on a weight percent basis, and the only one application of the topcoat composition results in a topcoat having a thickness ranging between about 16 and about 23 μm.

2. The method according to claim 1, wherein transmission of UVA radiation to the top surface of the wood is attenuated by at least about 80%.

3. The method according to claim 1, wherein transmission of UVA radiation to the top surface of the wood is attenuated by at least about 90%.

4. The method according to claim 1, wherein the UV absorber component comprises an organic UV absorber.

5. The method according to claim 4, wherein the organic UV absorber comprises at least one member selected from the group consisting of a cyanacrylate, an oxalanilide, a benzotriazole, a triazine, an hydroxyphenylbenzotriazole, 2-hydroxy-4-n-octoxybenzophenone, 2,2′-dihydroxy-4-methoxybenzophenone, poly-4-(2-acryloxyethoxy)-2-hydroxybenzophenone, [2,2′-thiobis(4-t-octylphenolate)]-n-butylamine nickel(II), 2,2′-(1,4-phenylene)bis[4H-3,1-benzoxazin-4-one], 2-(2′-hydroxy-5′-octylphenyl)-benzotriazole, 2-(2′-hydroxy-3′,5′-di-t-amylphenyl)benzotriazole, 2,4-bis(2,4-dimethylphenyl)-6-(2-hydroxy-4-iso-octyloxyphenyl)-s-triazine, 2-[4-[(2-hydroxy-3-(2′-ethyl)hexyl)oxy]-2-hydroxyphenyl]-4,6-bis(2,4-dimethylphenyl)-1,3,5-triazine, 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine, 2-(2H-benzotriazol-2-yl)-4,6-di-t-pentylphenol, a hexadecyl ester of 3,5-di-t-butyl-4-hydroxybenzoic acid, and mixtures thereof.

6. The method according to claim 1, wherein the HALS component comprises at least one member selected from the group consisting of hindered amine light stabilizers, monomeric hindered amine light stabilizers, oligomeric hindered amine light stabilizers, derivatives thereof, and mixtures thereof.

7. The method according to claim 1, wherein the HALS component comprises a free radical nitroxide-containing component.

8. The method according to claim 7, wherein the free radical nitroxide-containing component comprises a tetra-methyl piperidine-based composition.

9. The method according to claim 1, wherein the HALS component comprises at least one member selected from the group consisting of poly[[6-[(1,1,3,3-tetramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]]), poly[(6-morpholino-s-triazine-2,4-diyl)[2,2,6,6-tetramethyl-4-piperidyl)imino]-hexa methylene-[(2,2,6,6-tetramethyl-4-piperidyl)imino]], bis(2,2,6,6-tetramethyl-4-piperidyl)sebacate, bis(1,2,2,6,6-pentamethyl-4-piperidyl)sebacate, methyl 1,2,2,6,6-pentamethyl-4-piperidyl sebacate, 2,2,6,6-tetramethyl-4-piperidyl stearate, 3-dodecyl-1-(2,2,6,6-tetramethyl-4-piperidyl)-pyrrolidin-2,5-dione, and mixtures thereof.

10. The method according to claim 1, wherein the stain comprises a water-based stain.

11. The method according to claim 1, wherein the topcoat is of sufficient thickness to provide the wood with protection against moisture.

12. The method according to claim 1, wherein the topcoat is of sufficient thickness to provide an open pore feel to the top surface of the wood substrate.

13. The method according to claim 1, wherein the low gloss polyurethane comprises a composition which provides a 60 degree surface gloss rating no greater than about 25 gloss units measured according to ASTM D523-08 test conditions.

14. The method according to claim 1, wherein the low gloss polyurethane comprises a composition which provides a 60 degree surface gloss rating no greater than about 10 gloss units measured according to ASTM D523-08 test conditions.

15. The method according to claim 1, further comprising incorporating the wood substrate into an automotive vehicle interior.

16. The method according to claim 1, wherein the wood substrate comprises at least one wood selected from the group consisting of walnut, edinum, European lacewood, zebrano, maple, figured maple, olive ash, eucalyptus, and burls of the above-listed woods.

17. The method according to claim 1, wherein the wood substrate comprises a wood veneer.

18. The method according to claim 1, further comprising
adhering the wood substrate to a support component comprising metal, plastic or a composite material to form a part,
machining the part to desired dimensions, and
locating the part within an automotive interior.

19. A wood component for the interior of an automotive vehicle comprising:
a substrate having a top surface;
a stain-containing layer located on the top surface;
a polyurethane-containing layer comprising a low gloss polyurethane, a UV absorber component, and a HALS component located on top of the stain-containing layer, and
wherein the polyurethane-containing layer comprises a polyurethane composition which provides a 60 degree surface gloss rating of no greater than about 30 gloss units measured according to ASTM D523-08 test conditions, and the UV absorber component and the HALS component are present in a ratio of about 2:1 on a weight percent basis.

20. The component according to claim 19, wherein the polyurethane-containing layer has a thickness ranging between about 16 and about 23 μm.
